(19) United States
(12) Patent Application Publication
(10) Pub. No.: US 2012/0044345 A1
(43) Pub. Date: Feb. 23, 2012

(54) PANEL ASSEMBLY ALIGNMENT SYSTEM AND ALIGNMENT METHOD THEREOF

(76) Inventor: YUI-CHEN LIU, Taipei City (TW)

(21) Appl. No.: 12/938,917

(22) Filed: Nov. 3, 2010

(30) Foreign Application Priority Data
Aug. 18, 2010 (TW) 099127570

(51) Int. Cl. H04N 7/18

(52) U.S. Cl. 348/95

(57) ABSTRACT

A panel assembly alignment system and an alignment method thereof. A first panel has first alignment patterns arranged at equal pitches. A second panel has second alignment patterns arranged with a pitch between the adjacent patterns being wider as positions of the second alignment patterns are farther away from the pattern. A third panel has third alignment patterns and arranged with a pitch between adjacent patterns being narrower as positions of the third alignment patterns are farther away from the pattern. An operation unit controls a photographing unit to photograph each panel, so as to analyze an overlap portion between the first and the second alignment patterns, determine an offset direction of the second panel corresponding to the first panel, so that when the third panel is placed, the third alignment pattern conforming to the offset direction and a level of the overlap portion is overlapped with the overlap portion.

### CROSS-REFERENCE TO RELATED APPLICATION

This application claims the benefit of Taiwan Patent Application No. 099127570, filed on Aug. 18, 2010, which is hereby incorporated by reference for all purposes as if fully set forth herein.

### BACKGROUND OF THE INVENTION

1. Field of Invention

The present invention relates to a panel assembly system, and more particularly to a panel assembly alignment system and an alignment method thereof, capable of combining a determination technology for alignment photographing of a panel and a technology for changing a pitch between alignment patterns of a panel.

2. Related Art

In a naked-eye three-dimensional (3D) display panel in the prior art, in order to enable a left eye and a right eye of a user to receive different display signals, a color filter panel (CF panel) is usually attached to a normal cell panel, and then a slit cell/black matrix (BM) barrier is attached to the CF panel, so that the slit cell/BM barrier separates a frame signal output by the normal cell panel into display signals separately received by the left eye and the right eye.

However, no matter which type of slit cell/BM barrier structure is adopted, more than two times of panel assembly and attachment processes are required, such as a first assembly process in which a normal cell panel and a CF panel are combined, a second assembly process in which the CF panel and a slit cell/BM barrier are combined, a third assembly process in which other assembly elements need to be arranged between the panels, and so forth. As long as a situation of an alignment offset of a panel occurs during the assembly processes, for example, the CF panel is inclinedly attached to the normal cell panel, the assembled panel cannot completely separate the display signals capable of being received the left eye and right eye, thus lowering a quality that the panel displays a 3D optical image.

Next, although the manufacturers configure alignment marks on each panel to assist alignment, as a panel size is excessively large, when a slight position offset occurs in any assembly process of any panel, even if the alignment is performed according to the alignment marks, the portions far away from the alignment marks have gradually increasing offsets, and the alignment marks become completely useless.

Thus, the manufactures consider how to avoid or mitigate a problem that the panel cannot completely separate the display signals capable of being received by the left eye and the right eye due to alignment offsets, which causes lowering of the quality that the panel displays the 3D optical image.

### SUMMARY OF THE INVENTION

The present invention is directed to a panel assembly system and a method thereof capable of adjusting a pitch between alignment patterns of a panel, so as to complete assembly of a liquid crystal panel while maintaining a 3D viewing angle effect thereof.

To solve the above-mentioned problems, the invention provides a panel assembly alignment system, which comprises a plurality of first alignment patterns, a plurality of second alignment patterns, a plurality of third alignment patterns, an element placement unit, at least one photographing unit, and an operation unit.

The first alignment patterns are formed into a geometric pattern, and arranged at a calibration area of a first panel at equal pitches outwardly from a center of the geometric pattern; the second alignment patterns are formed into the geometric pattern and arranged at a calibration area of a second panel with a pitch between the adjacent second alignment patterns on a same straight line being wider as positions of the second alignment patterns are farther away from the center of the geometric pattern; the third alignment patterns are formed into the geometric pattern and arranged at a calibration area of a third panel with a pitch between the adjacent third alignment patterns on a same straight line being narrower as positions of the third alignment patterns are farther away from the center of the geometric pattern; the element placement unit is used for placing the first panel, the second panel, and the third panel in sequence, wherein the first alignment patterns correspond to the second alignment patterns, and the second alignment patterns correspond to the third alignment patterns; the at least one photographing unit is used for photographing alignment of the first alignment patterns and the second alignment patterns to form a first image, and continuously photographing alignment of the second alignment patterns and the third alignment patterns to form a second image; and the operation unit is used for acquiring the first image, so as to find out at least one first overlap pattern and at least one second overlap pattern overlapped with each other from the first alignment patterns and the second alignment patterns, and find out an offset direction of the second panel corresponding to the first panel, and overlapping at least one third overlap pattern conforming to the offset direction in the third alignment patterns with the second overlap pattern when controlling the element placement unit to place the third panel according to the second image.

To solve the above-mentioned problems, the invention provides a panel assembly alignment method, which comprises: placing a first panel on a carrying platform, wherein a plurality of first alignment patterns is arranged to form a geometric pattern and arranged at a calibration area of the first panel at equal pitches outwardly from a center of the geometric pattern; placing a second panel on the first panel, so the first alignment patterns correspond to a plurality of second alignment patterns of the second panel, the second alignment patterns are arranged to form the geometric pattern, and arranged at a calibration area of the second panel with a pitch between the adjacent second alignment patterns on a same straight line being wider as positions of the second alignment patterns are farther away from the center of the geometric pattern; finding out at least one first overlap pattern and at least one second overlap pattern overlapped with each other and an offset direction of the second panel corresponding to the first panel from the first alignment patterns and the second alignment patterns, so as to find out at least one third overlap pattern from a plurality of third alignment patterns of a third panel, wherein the third alignment patterns are arranged to form the geometric pattern, and arranged at a calibration area of the third panel with a pitch between the adjacent third alignment patterns on a same straight line being narrower as positions of the third alignment patterns are farther away from the center of the geometric pattern; and placing the third panel on the second panel, so the at least one third overlap pattern is overlapped with the at least one second overlap pattern.

The present invention is characterized in that the present invention is applicable to assembly processes of various slit cell/BM barrier structures, and assembly times are not limited. Next, when an alignment offset of the panel occurs during the assembly processes, the problem of the alignment offset of each panel can be modified by using improved alignment patterns in combination with a photographing alignment technology, so that the assembled panel can completely separate display signals capable of being received by a left eye and a right eye, thus improving a quality that the panel displays a 3D optical image, further, the present invention is applicable to an assembly process of a large-scale panel.

### BRIEF DESCRIPTION OF THE DRAWINGS

The present invention will become more fully understood from the detailed description given herein below for illustration only, and thus are not limitative of the present invention, and wherein:

FIGS. 1A and 1B are schematic views of architecture of a panel assembly alignment system according to an embodiment of the present invention;

FIGS. 2A and 2B are schematic views of arrangement of alignment patterns of a first panel according to an embodiment of the present invention;

FIGS. 2C and 2D are schematic views of arrangement of alignment patterns of a second panel according to an embodiment of the present invention;

FIGS. 2E and 2F are schematic views of arrangement of alignment patterns of a third panel according to an embodiment of the present invention;

FIGS. 2G to 2I are schematic views of a pitch between alignment patterns of each panel according to an embodiment of the present invention;

FIG. 3A is a schematic view of ideal overlap of alignment patterns according to an embodiment of the present invention;

FIG. 3B is a schematic view of content of a first image according to an embodiment of the present invention;

FIG. 3C is a schematic view of selection of third overlap patterns according to an embodiment of the present invention;

FIG. 3D is a schematic view of content of a second image according to an embodiment of the present invention;

FIG. 4A is another schematic view of content of a first image according to an embodiment of the present invention;

FIG. 4B is schematic view of another selection of third overlap patterns according to an embodiment of the present invention;

FIG. 4C is another schematic view of content of a second image according to an embodiment of the present invention;

FIGS. 5A and 5B are schematic views of another architecture of a panel assembly alignment system according to an embodiment of the present invention;

FIG. 6A is a schematic flow chart of a panel assembly alignment method according to an embodiment of the present invention; and

FIG. 6B is a detailed schematic flow chart of a process in FIG. 6A according to an embodiment of the present invention.

### DETAILED DESCRIPTION OF THE INVENTION

The preferred embodiments of the present invention are illustrated below in detail with reference to the accompanying drawings.

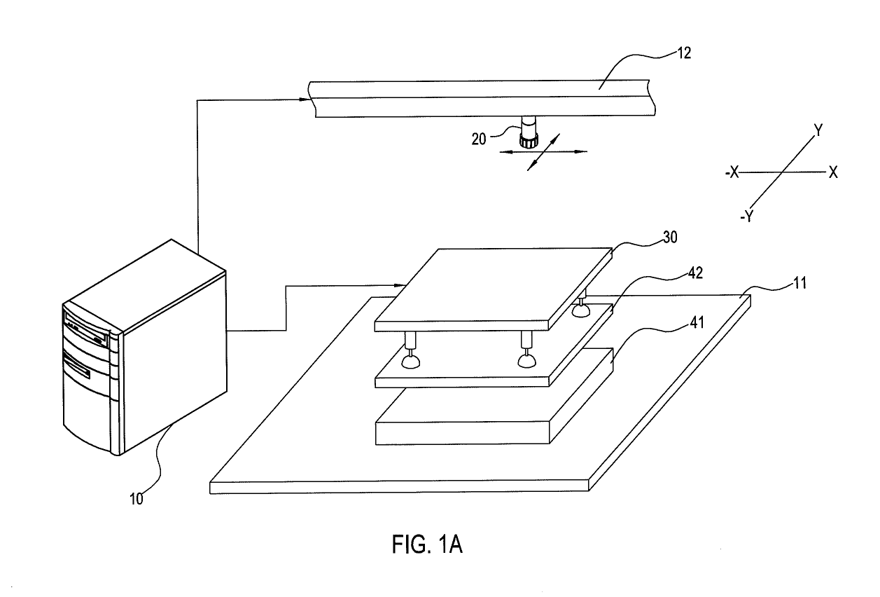

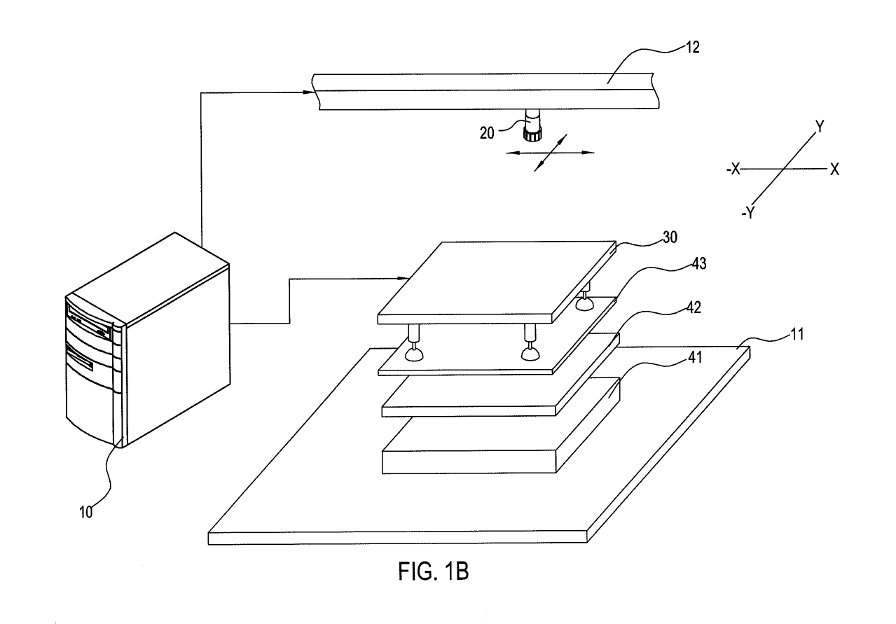

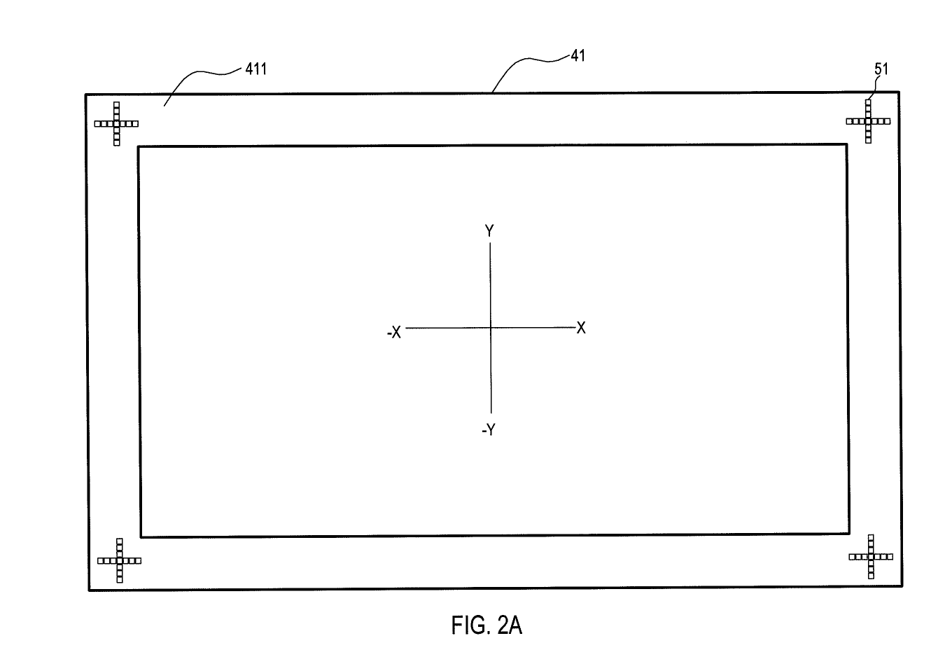

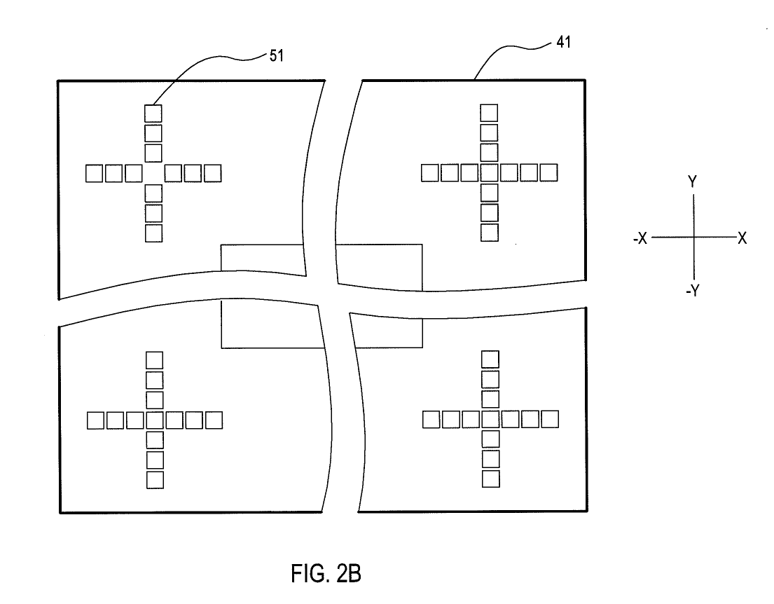

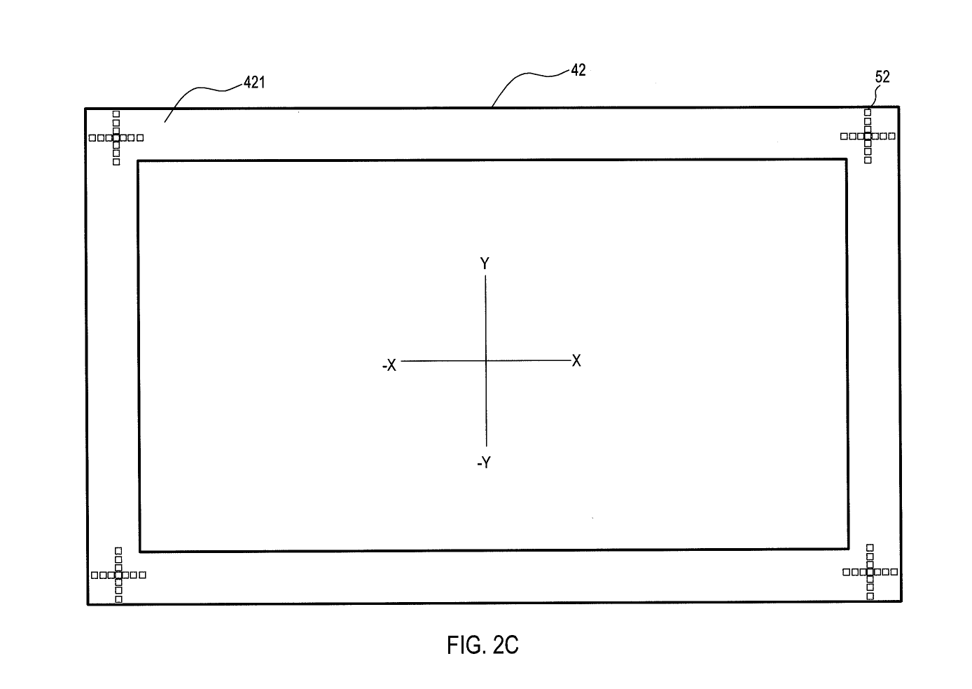

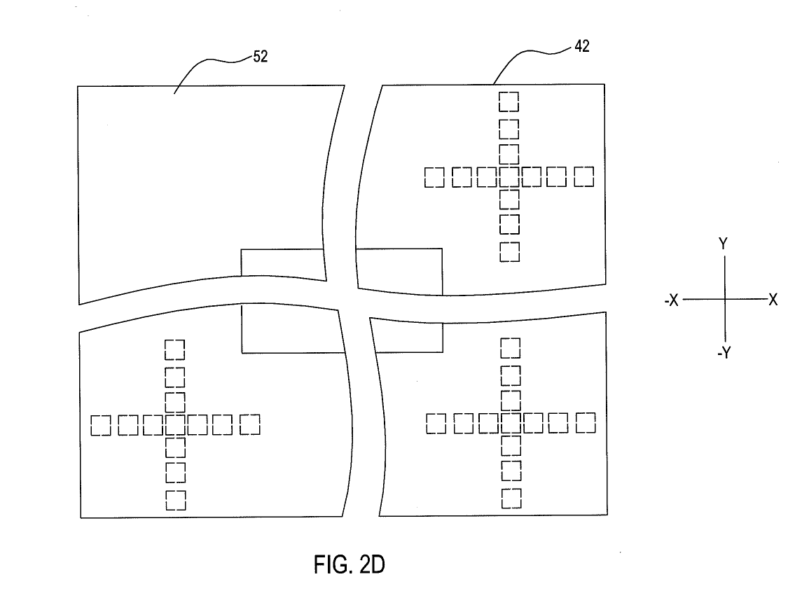

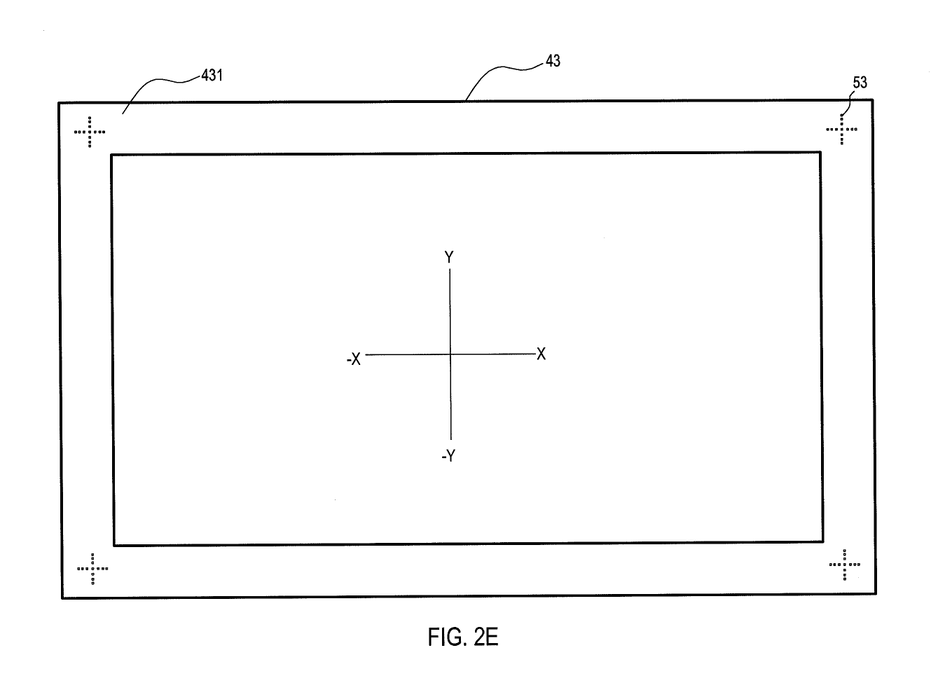

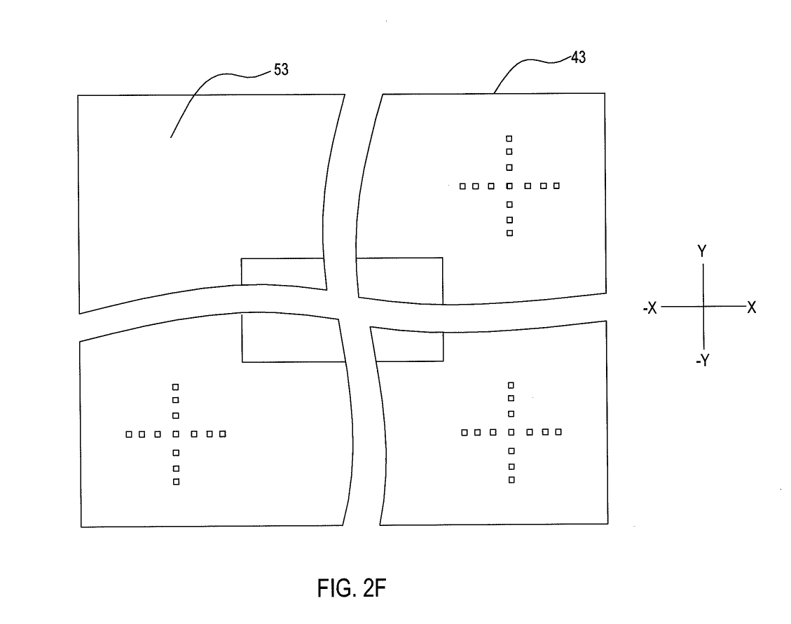

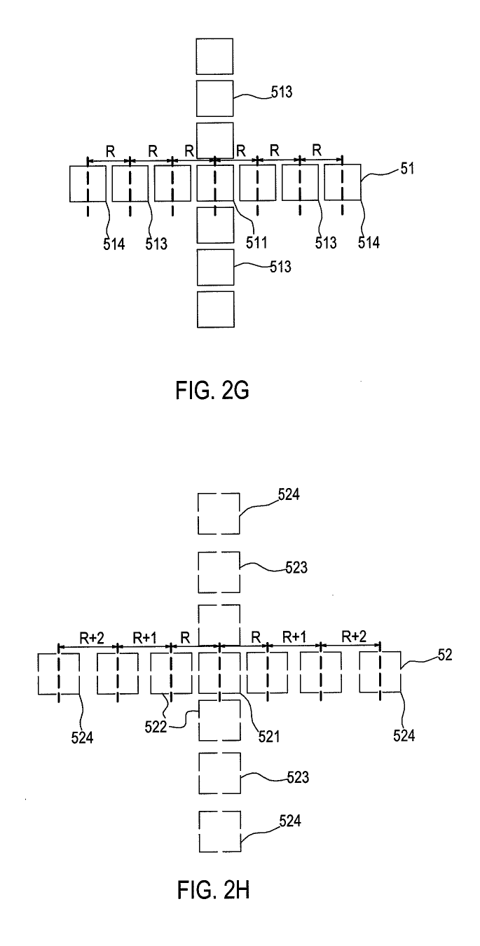

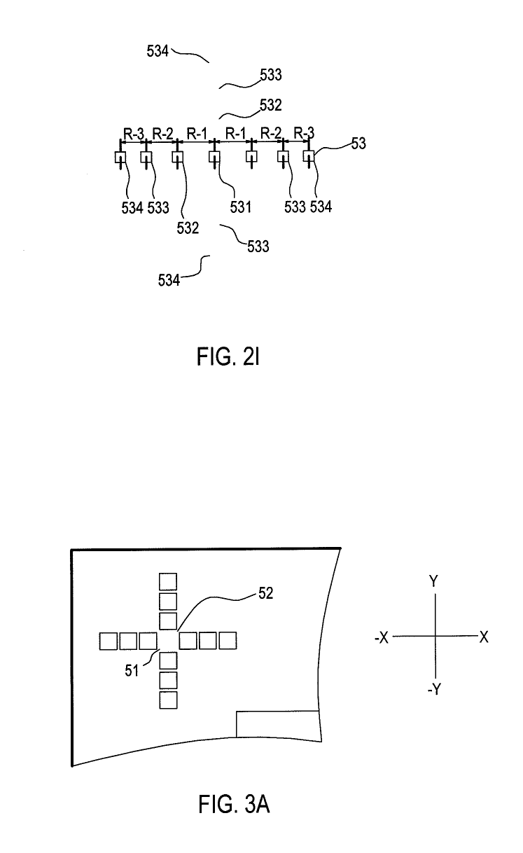

FIGS. 1A and 1B are schematic views of architecture of a panel assembly alignment system according to an embodiment of the present invention. FIGS. 2A and 2B are schematic views of arrangement of alignment patterns of a first panel according to an embodiment of the present invention. FIGS. 2C and 2D are schematic views of arrangement of alignment patterns of a second panel according to an embodiment of the present invention. FIGS. 2E and 2F are schematic views of arrangement of alignment patterns of a third panel according to an embodiment of the present invention. FIGS. 2G to 2I are schematic views of a pitch between alignment patterns of each panel according to an embodiment of the present invention. In this embodiment, assembly processes of panels of three layers are illustrated. A first panel 41 at a bottom layer is a normal cell panel, a second panel 42 at a middle layer is a CF panel, and a third panel 43 at an upper layer is a slit cell/BM barrier.

As shown in FIGS. 2A, 2B, and 2G, the first panel 41 includes a calibration area 411 at a periphery thereon. A plurality of first alignment patterns 51 is arranged on the calibration area 411. The first alignment patterns 51 form a geometric pattern for positioning, here the geometric pattern is, for example, a cross arranged by two straight lines being interlaced and perpendicular to each other, but the present invention is not limited herein.

The first alignment patterns 51 are outwardly arranged starting with a first alignment pattern 511 at a center of the cross, in which a pitch between every two adjacent first alignment patterns 51 is the same. It should be noted that the pitch here means a distance between centers of every two alignment patterns, and may also be calculated according to outer sidelines at a periphery of the alignment patterns. Here, each pitch is R.

As shown in FIGS. 2C, 2D, and 2H, the second panel 42 also includes a calibration area 421 at a periphery thereon. A plurality of second alignment patterns 52 is arranged on the calibration area 421. The second alignment patterns 52 form a geometric pattern similar to the cross formed by the first alignment patterns 51, and are arranged outwardly in a distributed manner starting with a second alignment pattern 521 at the center of the cross. However, it is different from the first alignment patterns 51 that the two adjacent second alignment patterns 52 on the same straight line are arranged with a pitch being wider as arrangement positions are closer to outside (second alignment patterns 521 being farther away from the center). In other words, except for the second alignment pattern 521 at the center, a pitch between the second alignment pattern 52 and a previous-level second alignment pattern 52 (the second alignment pattern 521 being closer to the center) is smaller than a pitch between the second alignment pattern 52 and a next-level second alignment pattern 52 (being farther away from the center point) by a preset distance.

Here, the second alignment pattern 521 at the center point is regarded as a first-level second alignment pattern, an adjacent second alignment pattern 52 at a periphery thereof is regarded as a second-level second alignment pattern 522, and an alignment pattern at a periphery of the second-level second alignment pattern 522 is a third-level second alignment pattern 523. The pitch between the first-level second alignment pattern (the second alignment pattern 521 at the center point) and the second-level second alignment pattern 522 is R, and the preset distance is 1, so that the pitch between the second-level second alignment pattern 522 and the third-level second alignment pattern 523 is R+1, the pitch between the third-level second alignment pattern 523 and a fourth-level second alignment pattern 524 is R+2, and so forth.

As shown in FIGS. 2E, 2F, and 2I, the third panel 43 also includes a calibration area 431 at a periphery thereon. A plurality of third alignment patterns 53 is arranged on the calibration area 431. The third alignment patterns 53 form a geometric pattern similar to the cross formed by the first alignment patterns 51, and are arranged outwardly in a distributed manner starting with a third alignment pattern 531 at the center of the cross. However, it is different from the first alignment patterns 51 that the two adjacent third alignment patterns 53 on the same straight line are arranged with a pitch being narrower as arrangement positions are closer to outside (the third alignment patterns 531 being farther away from the center). In other words, except for the third alignment pattern 531 at the center, a pitch between each third alignment pattern 53 and a previous-level third alignment pattern 53 (a third alignment pattern 531 being closer to the center) is larger than a pitch between the third alignment pattern 53 and a next-level third alignment pattern 53 (a third alignment pattern 531 being farther away from the center) by a preset distance. However, the preset distance is not limited to 1.

Here, the third alignment pattern 531 at the center is a first-level third alignment pattern, an adjacent third alignment pattern 53 at a periphery thereof is a second-level third alignment pattern 532, and an alignment pattern at a periphery of the second-level third alignment pattern 532 is a third-level third alignment pattern 533. The pitch between the first-level third alignment pattern (the third alignment pattern 531 at the center) and the second-level third alignment pattern 532 is R, and the preset distance is 1, so that the pitch between the second-level third alignment pattern 532 and the third-level third alignment pattern 533 is R−1, the pitch between the third-level third alignment pattern 533 and the fourth-level third alignment pattern 534 is R−2, and so forth.

As shown in FIG. 1A, an operation unit 10 first controls an element placement unit 30 to acquire the first panel 41 and then place the first panel 41 on a carrying platform 11. After the first panel 41 is placed, the operation unit 10 controls at least one photographing unit 20 to photograph an alignment situation between the first panel 41 and the second panel 42, that is, to photograph an overlap status between the first alignment pattern 51 and the second alignment pattern 52, so as to form a first image. It should be noted here that the element placement unit 30 can be an element removal and placement device or component for grasping and sucking a panel, such as a hollow suction cup or a mechanical manipulator. However, the present invention is not limited herein, and any device capable of performing panel removal or placement is applicable. The photographing unit 20 is connected through a movable table or a movable lever 12. The movable lever 12 is then controlled by the operation unit 10 to move the photographing unit 20, so the photographing unit 20 can move according to a specific track. However, the technologies that the photographing unit 20 moves the panel in combination with the movable lever 12 and the element placement unit 30 exist in the prior art and are well known to persons of ordinary skill in the technical field of the present invention, so the technologies are shown with simplified diagrams and are not illustrated here.

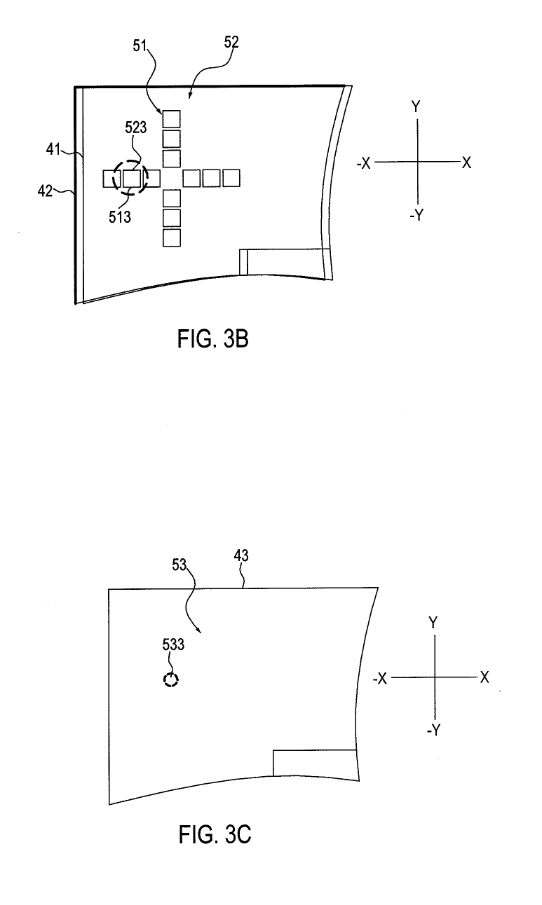

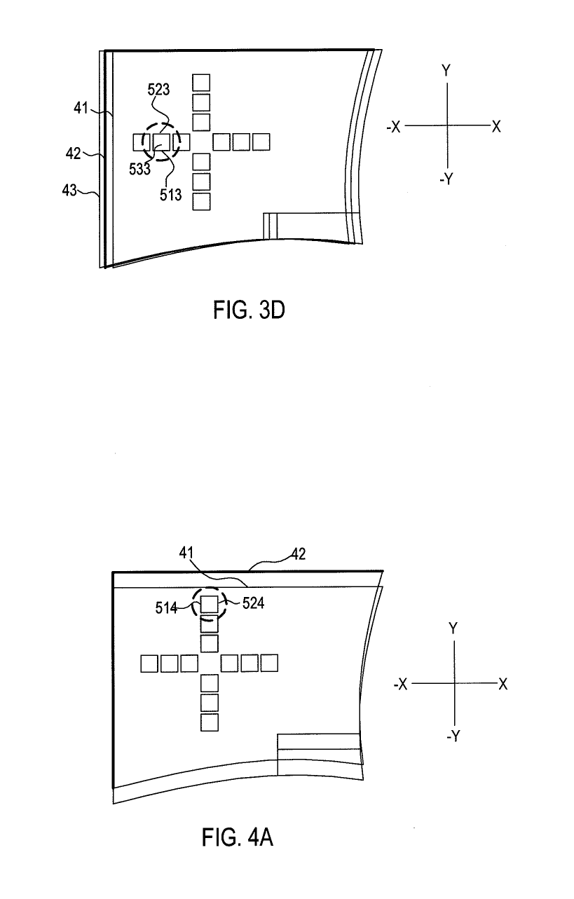

FIG. 3A is a schematic view of ideal overlap of alignment patterns according to an embodiment of the present invention. FIG. 3B is a schematic view of content of a first image according to an embodiment of the present invention. FIG. 3C is a schematic view of selection of a third overlap pattern according to an embodiment of the present invention. FIG. 3D is a schematic view of content of a second image according to an embodiment of the present invention. As shown in FIG. 3A, when the first panel 41 and the second panel 42 are overlapped, the most ideal overlap situation is that the first alignment pattern 511 at the center of the cross is overlapped with the second alignment pattern 521 at the center. However, practical alignment situations are different from the ideal situation.

As shown in FIGS. 1A and 3B, the operation unit 10 acquires a first image, and analyzes at least one first overlap pattern and at least one second overlap pattern overlapped with each other in all the first alignment patterns 51 and the second alignment patterns 52. As shown in FIG. 3B, it is assumed that when the first panel 41 and the second panel 42 are overlapped, the second panel 42 has a slight offset, so the overlapped alignment patterns are the third-level first alignment pattern 513 and the third-level second alignment pattern 523, and an offset direction is −X, which represents that the first overlap pattern is the third-level first alignment pattern 513 in the −X direction, and the second overlap pattern is the third-level second alignment pattern 523 in the −X direction, that is, the two alignment patterns inside a dotted-line circle.

As shown in FIG. 3C, the operation unit 10 analyzes which one among all the third alignment patterns 53 is the third overlap pattern corresponding to the first overlap pattern and second overlap pattern. As for this example, the operation unit 10 analyzes that the third-level third alignment pattern 533 in the offset direction −X is the qualified third overlap pattern.

As shown in FIGS. 1B and 3D, the operation unit 10 controls the photographing unit 20 to continuously photograph an overlap position between the first overlap pattern and the second overlap pattern, so as to form a second image. The operation unit 10 then controls the element placement unit 30 to place the third panel 43 on the second panel 42. When the third panel 43 is placed, the operation unit 10 analyzes a current alignment status of the panel according to the continuously generated second images, so the qualified third overlap pattern is overlapped with the second overlap pattern, such that the liquid crystal panel presents a display offset angle of the frame after adjustment of the panel assembly.

The photographing unit 20 photographs overlaps of the alignment patterns one by one by using arrangement of straight lines of the cross (no matter the first alignment pattern or the second alignment pattern is used as a reference) as a movement track. For FIGS. 1A and 3B, the photographing unit performs displacement photographing in an X-axis direction and a Y-axis direction (having no precedence order). Afterwards, the operation unit 10 analyzes an overlap degree between the first alignment pattern 51 and the second alignment pattern 52 at the same level by using the first alignment pattern 51 as a reference, finds out the first overlap pattern and the second overlap pattern overlapped with each other, and finds out an offset direction of the second panel 42 corresponding to the first panel 41.

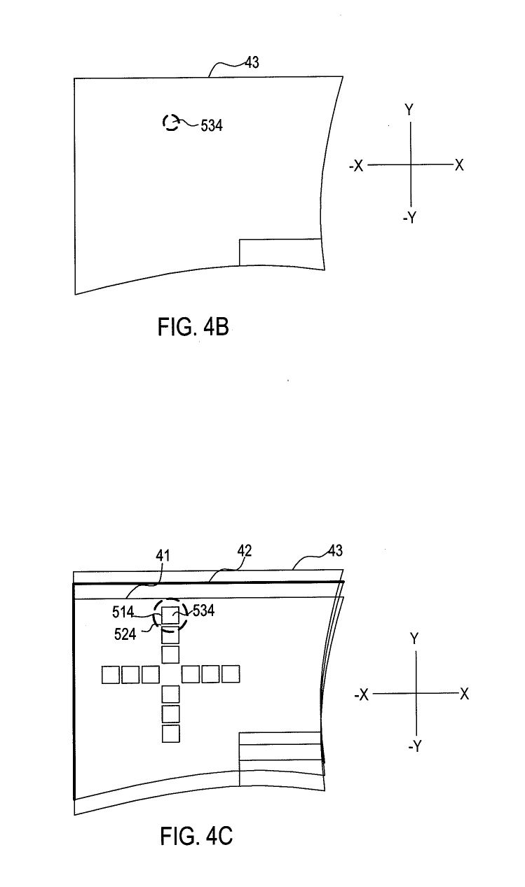

FIG. 4A is another schematic view of content of a first image according to an embodiment of the present invention. FIG. 4B is schematic view of another selection of a third overlap pattern according to an embodiment of the present invention. FIG. 4C is another schematic view of content of a second image according to an embodiment of the present invention.

As shown in FIGS. 1A and 4A, the operation unit 10 acquires a first image, and analyzes at least one first overlap pattern and at least one second overlap pattern overlapped with each other in all the first alignment patterns 51 and the second alignment patterns 52. As shown in FIG. 4A, it is assumed that when the first panel 41 and the second panel 42 are overlapped, the second panel 42 has a slight offset, so the overlapped alignment patterns are a fourth-level first alignment pattern 514 and a fourth-level second alignment pattern 524, and an offset direction is Y, which represents that the first overlap pattern is the fourth-level first alignment pattern 514 in Y direction, and the second overlap pattern is the fourth-level second alignment pattern 524 in the Y direction, that is, the two alignment patterns inside a dotted-line circle.

As shown in FIG. 4B, the operation unit 10 analyzes which one among all the third alignment patterns 53 is a third overlap pattern corresponding to the first overlap pattern and the second overlap pattern. As for this example, the operation unit 10 analyzes that the fourth-level third alignment pattern 534 in the offset direction Y is the qualified third overlap pattern.

As shown in FIGS. 1B and 4C, the operation unit 10 controls the photographing unit 20 to continuously photograph an overlap position between the first overlap pattern and the second overlap pattern, so as to form a second image. The operation unit 10 then controls the element placement unit 30 to place the third panel 43 on the second panel 42. When the third panel 43 is placed, a current alignment status is analyzed according to the continuously generated second images, so the qualified third overlap pattern is overlapped with the second overlap pattern, such that the liquid crystal panel presents a display offset angle of the frame after adjustment of the panel assembly.

Similarly, the offset direction of the second panel 42 corresponding to the first panel 41 is an X direction or a −Y direction, and the corresponding third overlap pattern also needs to be found out in this mode, so as to control and adjust an offset direction of the third panel 43 placed on the second panel 42.

In addition, the first alignment pattern 51, the second alignment pattern 52, and the third alignment pattern 53 are the same, the second alignment pattern 52 is larger than the third alignment pattern 53, and a size of the first alignment pattern 51 is between sizes of the second alignment pattern 52 and third alignment pattern 53, but the present invention is not limited herein.

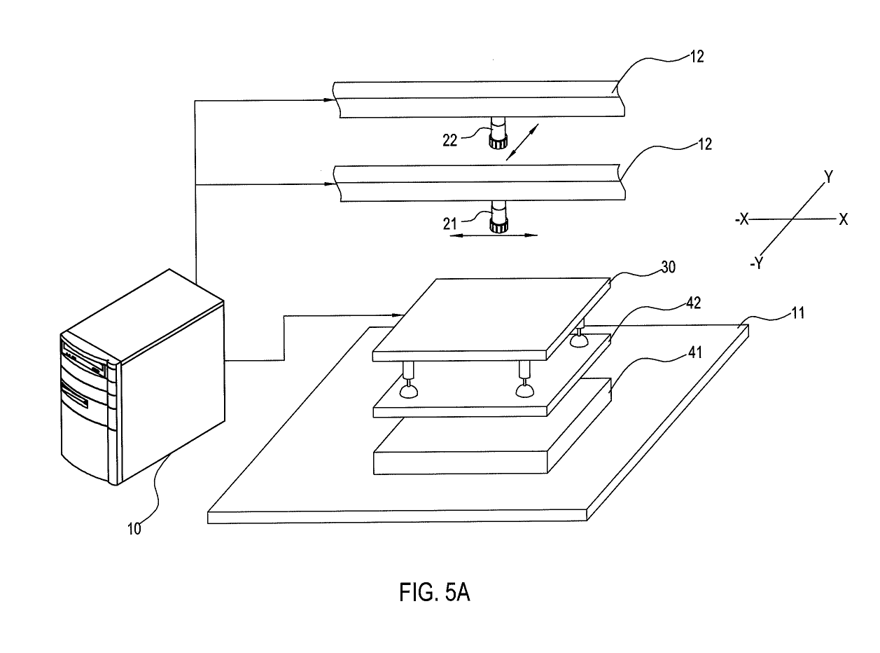

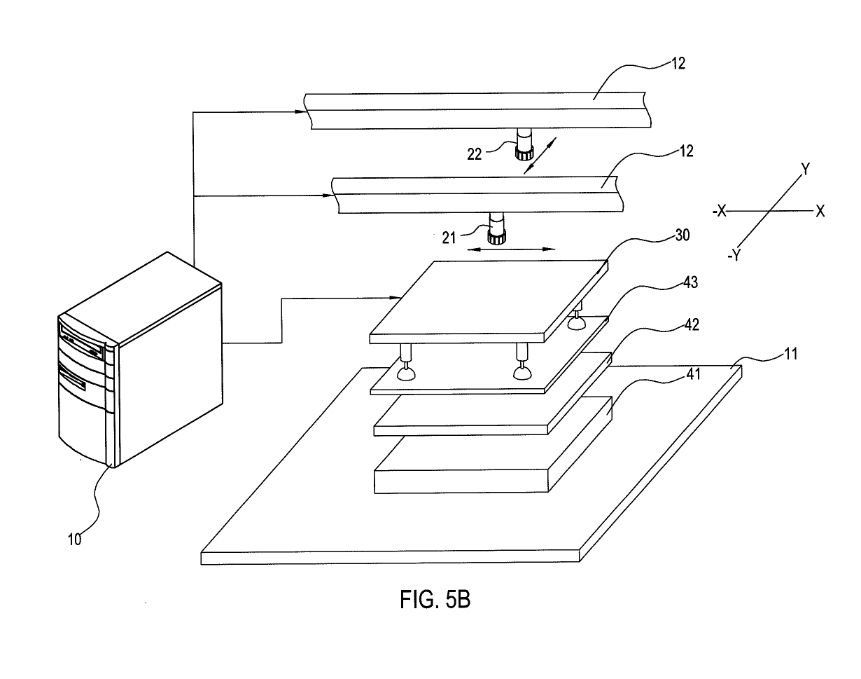

FIGS. 5A and 5B are schematic views of another architecture of a panel assembly alignment system according to an embodiment of the present invention. It is different from the architecture views shown in FIGS. 1A and 1B that a plurality of the photographing unit exists in this system, and two photographing units are taken as an example for illustration here.

In this embodiment, a first photographing unit 21 performs displacement photographing in an X-axis direction, and a second photographing unit 22 performs displacement photographing in a Y-axis direction. However, the pattern design and the size of the alignment pattern may cause that a group of overlap patterns exists in different axial directions, so the operation unit 10 acquires one or two groups of overlap patterns during determination of overlap patterns.

If two groups of overlap patterns exist, the operation unit 10 analyzes two third alignment patterns 53 conforming to the overlap pattern demand in the third alignment patterns 53, for serving as the third overlap patterns. Afterwards, the operation unit 10 controls the element placement unit 30 to place the third panel 43 on the second panel 42, and when the third panel 43 is placed, a current alignment offset status of the panel is analyzed according to the continuously generated second images, so the two qualified third overlap patterns are overlapped with two corresponding second overlap patterns, such that the liquid crystal panel presents a display offset angle of the frame after adjustment of the panel assembly.

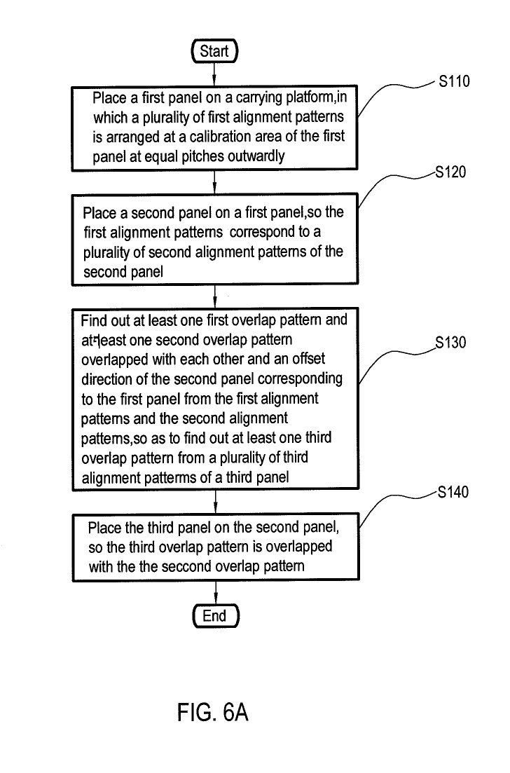

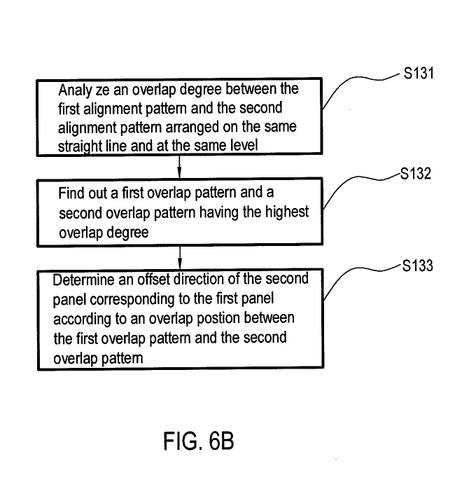

FIG. 6A is a schematic flow chart of a panel assembly alignment method according to an embodiment of the present invention, and FIG. 6B is a detailed schematic flow chart of the process in FIG. 6A according to an embodiment of the present invention. For ease of understanding, please refer to FIGS. 1A and 5B at the same time. The process of the method is described as follows.

A first panel 41 is placed on a carrying platform 11. A plurality of first alignment patterns 51 is arranged to form a geometric pattern and is arranged at a calibration area 411 of the first panel 41 at equal pitches outwardly from a center of the geometric pattern (Step S110). The first panel 41 includes a calibration area 411 at a periphery thereon. A plurality of first alignment patterns 51 is arranged on the calibration area 411. The first alignment patterns 51 form a shape for positioning. Here, a cross arranged by two straight lines being interlaced and perpendicular to each other is taken as an example, but the present invention is not limited herein. The first alignment pattern 51 is outwardly arranged starting with the first alignment pattern 511 at a center of the cross, and a pitch between every two adjacent first alignment patterns 51 is the same. It should be noted that here the pitch is a distance between centers of every two alignment patterns, and may also be calculated with outer sidelines at a periphery of the alignment patterns. Here, the pitch is R. The operation unit first controls the element placement unit to acquire the first panel, and places the first panel 41 on the carrying platform 11.

A second panel 42 is placed on the first panel 41, so the first alignment patterns 51 correspond to the plurality of second alignment patterns 52 of the second panel 42. The second alignment patterns 52 are arranged to form the geometric pattern, and arranged at a calibration area 421 of a second panel 42 with a pitch between adjacent second alignment patterns 52 on the same straight line being wider as positions of the adjacent second alignment patterns 52 farther away from the center of the geometric pattern (Step S120).

The second panel 42 also includes a calibration area 421 at a periphery thereon. A plurality of second alignment patterns 52 is arranged on the calibration area 421. The second alignment patterns 52 form a pattern similar to a cross formed by the first alignment patterns 51, and are arranged outwardly starting with the second alignment pattern 521 at the center of the cross. The two adjacent second alignment patterns 52 on the same straight line are arranged with a pitch being wider as arrangement positions are closer to outside (farther away from the center point of the cross). In other words, except for the second alignment pattern 521 at the center, a pitch between each second alignment pattern 52 and a previous-level second alignment pattern 52 (the second alignment pattern 521 being closer to the center) is smaller than a pitch between the second alignment pattern 52 and a next-level second alignment pattern 52 (the second alignment pattern 521 being farther away from the center) by a preset distance.

The operation unit 10 controls the element placement unit 30 to place the first panel 41 on the carrying platform 11, and then controls the at least one photographing unit 20 to photograph an overlap status between the first alignment pattern 51 and the second alignment pattern 52, so as to form a first image.

At least one first overlap pattern and at least one second overlap pattern overlapped with each other and an offset direction of the second panel 42 corresponding to the first panel 41 are found out from the first alignment patterns 51 and second alignment patterns 52, so as to find out at least one third overlap pattern from a plurality of third alignment patterns 53 of a third panel 43. The third alignment patterns 53 are also arranged to form the geometric pattern, and are arranged at a calibration area 431 of a third panel 43 with a pitch between adjacent third alignment patterns 53 on the same straight line being narrower as positions of the third alignment patterns 53 are farther away from the center of the geometric pattern (Step S130). The operation unit 10 acquires a first image, and analyzes at least one first overlap pattern and at least one second overlap pattern overlapped with each other in all the first alignment patterns 51 and the second alignment patterns 52.

However, the method for analyzing the overlap of the alignment patterns is described as follows.

An overlap degree between the first alignment pattern 51 and the second alignment pattern 52 arranged on the same straight line and at the same level is analyzed (Step S131). The photographing unit 20 photographs overlaps of the alignment patterns one by one by using arrangement of straight lines of a cross (no matter the first alignment patterns or the second alignment patterns) as a movement track. The first image formed through photographing is received by the operation unit 10, and the overlap degree between the first alignment pattern 51 and the second alignment pattern 52 at the same level is analyzed.

A first overlap pattern and a second overlap pattern having the highest overlap degree are found out (Step S132). The operation unit 10 may analyze the first alignment pattern 51 and the second alignment pattern 52 having the highest overlap degree and at the same level, for serving as the first overlap pattern and the second overlap pattern. Afterwards, according to an overlap position between the first overlap pattern and the second overlap pattern, an offset direction of the second panel 42 corresponding to the first panel 41 is determined (Step S133). Taking FIG. 3B as an example, the operation unit 10 determines that the third-level first alignment pattern 513 and the third-level second alignment pattern 523 in the −X direction are overlapped with each other, and recognizes that the offset direction of the second panel 42 corresponding to the first panel 41 is −X. Further, taking FIG. 4C as an example, the operation unit 10 determines that the fourth-level first alignment pattern 514 and the fourth-level second alignment pattern 524 in the Y direction are overlapped with each other, and recognizes that the offset direction of the second panel 42 corresponding to the first panel 41 is Y.

The third panel 43 is placed on the second panel 42, so the third overlap pattern is overlapped with the second overlap pattern (Step S140). The operation unit 10 analyzes which one among all the third alignment patterns 53 is a third overlap pattern corresponding to the first overlap pattern and the second overlap pattern. Afterwards, the operation unit 10 controls the photographing unit 20 to continuously photograph an overlap position between the first overlap pattern and the second overlap pattern, so as to form a second image. The operation unit 10 then controls the element placement unit 30 to place the third panel 43 on the second panel 42. When the third panel 43 is placed, according to the continuously generated second images, the current alignment status of the panel is analyzed, so the qualified third overlap pattern is overlapped with the second overlap pattern, such that the liquid crystal panel presents a display offset angle of the frame after adjustment of the panel assembly.

In conclusion, only the implementation modes or embodiments for presenting the technical means for solving the problems of the present invention are recorded, which are not intended to limit the patent scope of the present invention. All the equivalent changes and modifications that accord with the meanings of the patent scope of the present invention or that are made according to the patent scope of the present invention should fall within the scope of the present invention.

What is claimed is:

1. A panel assembly alignment system, comprising:
a plurality of first alignment patterns, forming a geometric pattern, and arranged at a calibration area of a first panel at equal pitches outwardly from a center of the geometric pattern;
a plurality of second alignment patterns, forming the geometric pattern, and arranged at a calibration area of a second panel with a pitch between the adjacent second alignment patterns on a same straight line being wider as positions of the second alignment patterns are farther away from the center of the geometric pattern;
a plurality of third alignment patterns, forming the geometric pattern, arranged at a calibration area of a third panel with a pitch between the adjacent third alignment patterns on a same straight line being narrower as positions of the third alignment patterns are farther away from the center of the geometric pattern;
an element placement unit, for placing the first panel, the second panel, and the third panel in sequence, wherein the first alignment patterns correspond to the second alignment patterns, and the second alignment patterns correspond to the third alignment patterns;
at least one photographing unit, photographing alignment of the first alignment patterns and the second alignment patterns to form a first image, and continuously photographing alignment of the second alignment patterns and the third alignment patterns to form a second image; and
an operation unit, acquiring the first image, so as to find out at least one first overlap pattern and at least one second overlap pattern overlapped with each other from the first alignment patterns and the second alignment patterns, and find out an offset direction of the second panel corresponding to the first panel, and overlapping at least one third overlap pattern conforming to the offset direction in the third alignment patterns with the second overlap pattern when controlling the element placement unit to place the third panel according to the second image.

2. The panel assembly alignment system according to claim 1, wherein when the second alignment patterns are arranged, a plurality of levels is formed outwardly from the center of the geometric pattern, except for the second alignment pattern at the center of the geometric pattern, a pitch between the second alignment pattern at each level and a previous-level second alignment pattern exceeds a pitch between the second alignment pattern and a next-level second alignment pattern by a preset distance.

3. The panel assembly alignment system according to claim 1, wherein when the third alignment patterns are arranged, except for the third alignment pattern at the center of the geometric pattern, a pitch between the third alignment pattern at each level and a previous-level third alignment pattern is smaller than a pitch between the third alignment pattern and a next-level third alignment pattern by a preset distance.

4. The panel assembly alignment system according to claim 1, wherein when the first alignment patterns and the second alignment patterns are overlapped to obtain the two first overlap patterns and the two second overlap patterns, a pattern overlap level between the first overlap patterns and the second overlap patterns and the offset direction of the second panel corresponding to the first panel are calculated, so as to find out the two third overlap patterns from the third alignment patterns, and overlap the third overlap patterns with the second overlap patterns when the element placement unit is controlled to place the third panel.

5. The panel assembly alignment system according to claim 1, wherein the geometric pattern is a cross arranged by two straight lines being interlaced and perpendicular to each other, the photographing unit photographs overlap of the alignment patterns one by one by using arrangement of the straight lines as a movement track, and the operation unit finds out the first overlap pattern and the second overlap pattern overlapped with each other according to an overlap degree between the first alignment pattern and the second alignment pattern at a same level.

6. The panel assembly alignment system according to claim 1, wherein the first alignment pattern, the second alignment pattern, and the third alignment pattern are same, the second alignment pattern is larger than the third alignment pattern, and the first alignment pattern has a size between sizes of the second alignment pattern and the third alignment pattern.

7. A panel assembly alignment method, comprising:
placing a first panel on a carrying platform, wherein a plurality of first alignment patterns is arranged to form a geometric pattern and arranged at a calibration area of the first panel at equal pitches outwardly from a center of the geometric pattern;
placing a second panel on the first panel, so the first alignment patterns correspond to a plurality of second alignment patterns of the second panel, the second alignment patterns are arranged to form the geometric pattern, and arranged at a calibration area of the second panel with a pitch between the adjacent second alignment patterns on a same straight line being wider as positions of the second alignment patterns are farther away from the center of the geometric pattern;
finding out at least one first overlap pattern and at least one second overlap pattern overlapped with each other and an offset direction of the second panel corresponding to the first panel from the first alignment patterns and the second alignment patterns, so as to find out at least one third overlap pattern from a plurality of third alignment patterns of a third panel, wherein the third alignment patterns are arranged to form the geometric pattern, and arranged at a calibration area of the third panel with a pitch between the adjacent third alignment patterns on a same straight line being narrower as positions of the third alignment patterns are farther away from the center of the geometric pattern; and
placing the third panel on the second panel, so the at least one third overlap pattern is overlapped with the at least one second overlap pattern.

8. The panel assembly alignment method according to claim 7, wherein when the second alignment patterns are arranged, a plurality of levels is formed outwardly from the center of the geometric pattern, except for the second alignment pattern at the center of the geometric pattern, a pitch between the second alignment pattern at each level and a previous-level second alignment pattern exceeds a pitch between the second alignment pattern and a next-level second alignment pattern by a preset distance.

9. The panel assembly alignment method according to claim 7, wherein when the third alignment patterns are arranged, except for the third alignment pattern at the center of the geometric pattern, a pitch between the third alignment pattern at each level and a previous-level third alignment pattern is smaller than a pitch between the third alignment pattern and a next-level third alignment pattern by a preset distance.

10. The panel assembly alignment method according to claim 7, wherein when the first alignment patterns and the second alignment patterns are overlapped to obtain the two first overlap patterns and the two second overlap patterns, the two third overlap patterns are found out from the third alignment patterns according to a pattern overlap level of the first overlap patterns and the second overlap patterns and the offset direction of the second panel corresponding to the first panel, and when the third panel is placed, the third overlap patterns are overlapped with the second overlap patterns.

11. The panel assembly alignment method according to claim 7, wherein the step of finding out the at least one first overlap pattern and the at least one second overlap pattern overlapped with each other and the offset direction of the second panel corresponding to the first panel from the first alignment patterns and the second alignment patterns comprises:
analyzing an overlap degree between the first alignment pattern and the second alignment pattern arranged on the same straight line and at a same level;
finding out the first overlap pattern and the second overlap pattern having a highest overlap degree; and
determining the offset direction of the second panel corresponding to the first panel according to the first overlap pattern and the second overlap pattern.

12. The panel assembly alignment method according to claim 7, wherein the first alignment pattern, the second alignment pattern, and the third alignment pattern are the same, the second alignment pattern is larger than the third alignment pattern, and a size of the first alignment pattern is between sizes of the second alignment pattern and the third alignment pattern.
